(19) United States
(12) Patent Application Publication
(10) Pub. No.: US 2024/0343076 A1
(43) Pub. Date: Oct. 17, 2024

(54) Portable Small Tire Changing Device

(71) Applicant: Sean Patterson, Windsor (CA)

(72) Inventor: Sean Patterson, Windsor (CA)

(21) Appl. No.: 18/632,382

(22) Filed: Apr. 11, 2024

Related U.S. Application Data
(60) Provisional application No. 63/495,648, filed on Apr. 12, 2023.

(51) Int. Cl. B60C 25/138

(52) U.S. Cl. CPC B60C 25/138

(57) ABSTRACT

A small tire changing device designed to easily change a small tire to enhance the efficiency for competitive go-karts, lawn mowers, tractors, and/or small vehicles. The device features a durable base, square steel tubing, and an integrated small tire changing portion. A tire bead breaker unit, equipped with an ergonomic handle and a specialized C-shaped or curvilinear bead breaker component is used for breaking the bead of a tire off the rim. The tire changing portion provides a platform for tire manipulation, and the device includes a convenient storage solution for an included pry bar. The device provides all the necessary tools for changing a small tire and does not require a user to bend or sit on their knees during the tire changing process.

### CROSS-REFERENCE TO RELATED APPLICATION

The present application claims priority to, and the benefit of, U.S. Provisional Application No. 63/495,648, which was filed on Apr. 12, 2023 and is incorporated herein by reference in its entirety.

### FIELD OF THE INVENTION

The present invention relates generally to the field of tire changing systems. More specifically, the present invention relates to a novel go-kart tire, lawn mower tire, or tractor tire (i.e., small tire) changing device that includes a durable base, an integrated go-kart tire or small tire changing portion, and a tire bead breaker unit. The bead breaker unit has an ergonomic handle and a specialized C-shaped or curvilinear bead breaker for breaking the bead of a tire off the rim. The tire changing portion provides a platform for tire manipulation, and the device includes a convenient storage solution for an included pry bar. Accordingly, the present disclosure makes specific reference thereto. Nonetheless, it is to be appreciated that aspects of the present invention are also equally applicable to other like applications, devices, and methods of manufacture.

### BACKGROUND

By way of background, in competitive go-kart racing, the race includes multiple “heats” or rounds of races. Like other racing competitions, optimal control of the go-kart is crucial for racers to perform well on the track. During a race, when a go-kart tire or small tire loses traction, the tire can lead to skidding or sliding on the track. This loss of control can be frustrating for the racer and as well as dangerous. Tires also go through premature wear and tear during different rounds of races. To avoid loss of control due to tire wear and tear, go-kart racers change tires in between heats of the race. However, the conventional process of changing go-kart tire or small tires is time-consuming and laborious. The process requires physical effort and dexterity to remove and install tires, especially considering the tight fit of the tire beads on the rim.

Further, a plurality of tools such as pry bars, bead breakers, and potentially other equipment are required for changing tires which are required to be separately procured. Often, racers need assistance from track personnel or fellow racers to complete the task. Go-kart racers desire a device to address the challenges associated with the go-kart tire or small tire changing process and to streamline the tire-changing process.

Therefore, there exists a long felt need in the art for a go-kart tire or small tire changing device or machine. There is also a long felt need in the art for a go-kart tire or small tire changing device that includes all necessary tools for changing a go-kart tire or small tire. Additionally, there is a long felt need in the art for a go-kart tire or small tire changing machine that enables go kart racers to quickly change tires between heats. Moreover, there is a long felt need in the art for a go- kart tire or small tire changing machine that eliminates the need of assistance from other individuals for the go-kart tire or small tire changing process. Further, there is a long felt need in the art for a novel go-kart tire or small tire changing device that provides a bead breaker, tire changing platform, and a pry bar. Finally, there is a long felt need in the art for a simple and efficient go kart tire changing device that improves tire changing capabilities, saving considerable time and effort of go-kart racers.

The subject matter disclosed and claimed herein, in one embodiment thereof, comprises a go-kart tire or small tire changing machine. The machine features a generally square or rectangular metal base. A square steel tubing extending upwards from the base and a go-kart tire or small tire changing portion integrated at an upper end of the tubing. A tire bead breaker that includes a handle with an ergonomic grip, a C-shaped or curvilinear bead breaker portion for breaking the bead of a tire from an edge of a rim. The C-shaped or curvilinear bead breaker portion is operable when the handle is pushed down to lower down the C-shaped or curvilinear bead breaker portion to exert pressure on a go-kart tire or small tire placed on the base to break the bead off the rim. The go-kart tire or small tire changing portion includes a platform for supporting the tire. A pry bar is included in the device and is stored in a groove positioned on the base.

In this manner, the go-kart tire or small tire changing machine of the present invention accomplishes all of the forgoing objectives and provides users with a portable and versatile solution for bead breaking and tire changing of a go-kart tire or small tire. The machine provides all the tools for changing a go-kart tire or small tire. The machine has a platform that allows a user to change the tire without bending or elbowing.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a go-kart tire or small tire changing device. The device further comprises a generally square or rectangular base. A vertical square steel tubing extending upwards from the base and a go-kart tire or small tire changing portion integrated at an upper end of the tubing. A tire bead breaker unit slidably attached to the steel tubing and includes a handle with an ergonomic grip, a C-shaped or curvilinear bead breaker portion for breaking the bead of a tire. The C-shaped or curvilinear bead breaker portion is operable when the handle is pushed down to lower down the C-shaped or curvilinear bead breaker portion to exert pressure on a go-kart tire or small tire placed on the base to break the bead off the rim. The go-kart tire or small tire changing portion includes a platform for supporting the tire. A pry bar is included in the device and is stored in a groove positioned on the base.

In yet another embodiment, a simple and efficient go kart tire changing device is disclosed. The device includes a metal base, a square steel tubing extending vertically upwards from the base, a tire changing part positioned at the top of the tubing, an adjustable bead breaker integrated into the tubing, the bead breaker includes a C-shaped or curvilinear component used for conforming to a portion of a bead of the tire and also used for breaking the bead off the rim upon applying pressure using an elongated handle. The tire changing part includes a platform to support the tire whose bead is broken, a pry bar having a bevel end and an opposite end, the bevel end is inserted between the tire bead and rim edge for removing the tire from the rim and the opposite end has a supporting member used for applying force on a new tire to seal with the rim edge.

The device of the present invention includes the pry bar which includes a supporting fastener which is secured to one of the fastening slots of the tire changing part for easy rotation of the pry bar during installation of the new tire.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the go-kart tire or small tire changing device of the present invention in accordance with the disclosed architecture;

FIG. 2 illustrates an enlarged view showing the bead breaking process of a go-kart tire or small tire using the go-kart tire or small tire changing device of the present invention in accordance with the disclosed structure;

FIG. 3 illustrates the tire positioned on the platform of the go-kart tire or small tire changing portion of the go-kart tire or small tire changing device of the present invention for removing the tire in accordance with the disclosed architecture;

FIG. 4 illustrates a perspective view showing reinstallation of a new tire on the rim using the go-kart tire or small tire changing machine of the present invention in accordance with the disclosed structure; and

FIG. 5 illustrates a flow chart depicting a process of replacing a go-kart tire or small tire using the go-kart tire or small tire changing device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a go-kart tire or small tire changing device or machine. There is also a long felt need in the art for a go-kart tire or small tire changing device that includes all necessary tools for changing a go-kart tire or small tire. Additionally, there is a long felt need in the art for a go-kart tire or small tire changing machine that enables go kart racers to quickly change tires between heats. Moreover, there is a long felt need in the art for a go-kart tire or small tire changing machine that eliminates the need of assistance from other individuals for the go-kart tire or small tire changing process. Further, there is a long felt need in the art for a novel go-kart tire or small tire changing device that provides a bead breaker, tire changing platform and a pry bar. Finally, there is a long felt need in the art for a simple and efficient go kart tire changing device that improves tire changing capabilities, saving considerable time and effort of go-kart racers.

The present invention, in one exemplary embodiment, is a go kart tire changing device. The device includes a metal base, a steel tubing extending vertically upwards from the base, a tire changing part positioned at the top of the tubing, a bead breaker integrated into the tubing, the bead breaker includes a C-shaped or curvilinear component for breaking the bead off the rim upon applying pressure using an elongated handle. The tire changing part includes a platform to support the tire whose bead is broken, a pry bar having a bevel end and an opposite end, the bevel end is inserted between the tire bead and rim edge for removing the tire from the rim and the opposite end has a supporting member used for applying force on a new tire to seal with the rim edge.

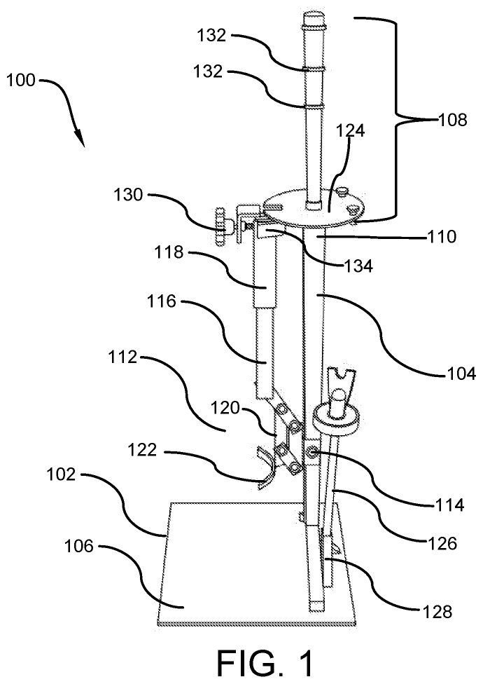

Referring initially to the drawings, FIG. 1 illustrates a perspective view of the go-kart tire or small tire changing device of the present invention in accordance with the disclosed architecture. The go-kart tire or small tire changing device 100 is a portable and compact device used for simple, expedited, and efficient go-kart tire or small tire changing process. More specifically, the device 100 includes a generally square or rectangular base 102 which can be made of a durable and heavy metal for providing stability to the device 100. A square steel tubing 104 extends vertically upwards from the top surface 106 of the base 102 and a go-kart tire or small tire changing portion 108 is integrated to the top end 110 of the tubing 104.

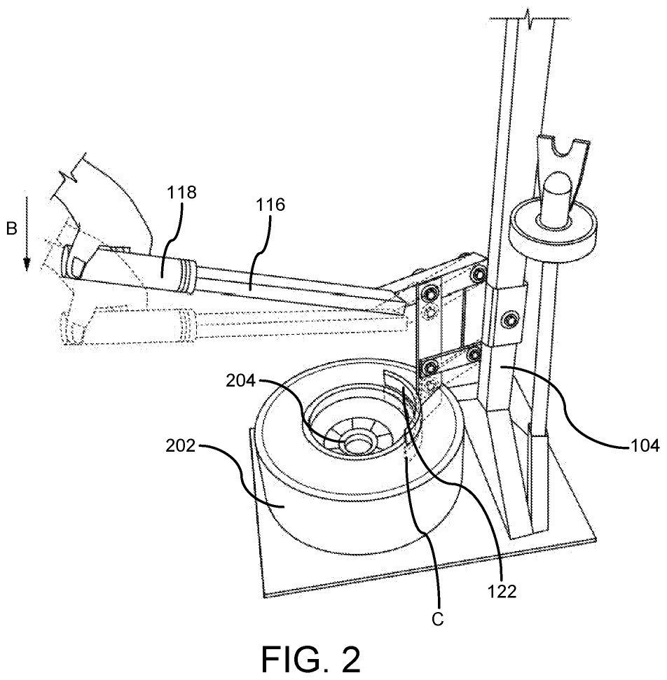

A tire bead breaker unit 112 is slidably attached to the steel tubing 104 wherein the unit 112 can slide along the tubing 104 by unscrewing the fastening screw 114. The bead breaker unit 112 includes a handle 116 with an ergonomic grip 118 for pivotally moving relative to a lever portion 120 of the bead breaker unit 112. The bead breaker unit 112 includes a C-shaped or curvilinear bead breaker portion 122 that is used for breaking bead of a tire as illustrated in FIG. 2. The handle 116 when pushed down, allows the C-shaped or curvilinear bead breaker portion 122 to push into a go-kart tire or small tire and helps in breaking the bead.

The go-kart tire or small tire changing portion 108 includes a platform 124 on which a tire can be changed using a pry bar 126. The pry bar 126 is included with the tire-changing device 100 and is stored in a groove 128 positioned on top surface 106 of the base 102. The pry bar 126 is used to remove the old tire and reinstall a new tire. The tire changing portion 108 includes a fastener 130 for fastening the platform 124 at different positions along the go-kart tire or small tire changing portion 108. Further, the portion 108 includes a plurality of fastening slots 132 for allowing the pry bar 126 to install the new tire. For holding the handle 116 in a substantially vertical position during non-use of the device 100, a holder or clamp 134 is included at the bottom surface of the platform 124. The holder or clamp 134 holds the grip 118 and keeps the handle 116 in the vertical position.

It will be apparent to a person skilled in the art that the go-kart tire or small tire changing device 100 provides all necessary tools for allowing a user to quickly change a go-kart tire or small tire without any external help. Using the device 100, competitive go-kart racers can save time changing tires between heats while maintaining safety. The go-kart tire or small tire changing machine 100 is compact and can be stored and carried easily.

The metal base 102 can have a size of 12-inch by 16-inch and length of the tubing 104 can be in the range from about 24 inches to about 32 inches extending from the base 102 to the top end 110.

FIG. 2 illustrates an enlarged view showing the bead breaking process of a go-kart tire or small tire using the go-kart tire or small tire changing device of the present invention in accordance with the disclosed structure. For breaking bead of a tire 202 off the rim 204, the tire 202 is placed on the base 102 and the tire bead breaker unit 112 is adjusted to position on the tubing 104 such that the C-shaped or curvilinear bead breaker portion 122 touches the tire 202 along the rim 204. The handle 116 is held by a user 206 using the ergonomic grip 118 and is pushed down (as shown by “B”) allowing the C-shaped or curvilinear bead breaker portion 122 to push the tire 202 (shown in the position of the C-shaped or curvilinear bead breaker portion 122 by “C” in phantom lines) to break seal of the tire 202 off the rim 204. The lever portion 120 includes the lever and provides a significant force to break the bead of the tire off the rim. The C-shape conforms to a peripheral portion of the rim to remove the tire from the rim 204.

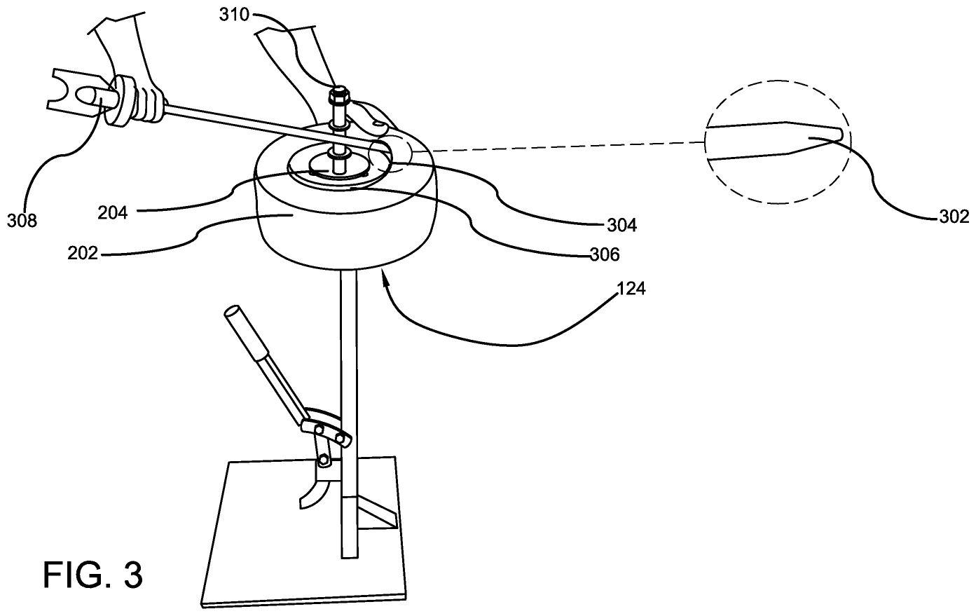

FIG. 3 illustrates the tire positioned on the platform 124 of the go-kart tire or small tire changing portion 108 of the go-kart tire or small tire changing device of the present invention for removing the tire in accordance with the disclosed architecture. After breaking the bead of the tire 202 off the rim 204 as described in FIG. 2, the tire 202 is placed on the platform 124 wherein the platform 124 is fastened for a stable position. The platform 124 is designed to provide a stable place for supporting a conventional go-kart tire or small tire. The rim 204 is inserted from the top end 310 of the tire changing portion 108.

The bevel or claw end 302 of the pry bar 126 is inserted between the tire bead 304 and the rim edge 306 and a downward force is applied on the tire bead 304. The pry bar 126 is pushed upwards from the opposite end 308 to lift the bead 304 over the rim edge 306. The process is performed along the circumference of the rim 204 while continuing to pry the tire bead 304 over the rim edge 306 to remove the tire 202 from the rim 204.

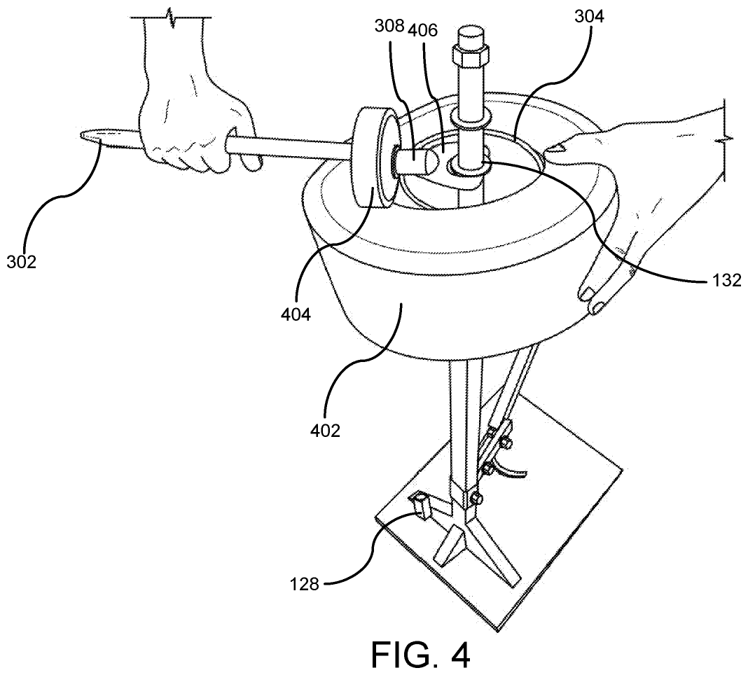

FIG. 4 illustrates a perspective view showing a perspective view showing reinstallation of a new tire on the rim using the go-kart tire or small tire changing machine of the present invention in accordance with the disclosed structure. Once the go-kart tire or small tire 202 is removed from the rim 204 as described above in the disclosure, a new tire 402 is placed along the rim 204 while the rim 204 is positioned on the platform 124. The opposite end 308 of the pry bar 126 has a tire inserting member 404 which is rolled and pressed against bead of the tire 402 to seal with edge 306 of the rim 204. A supporting fastener 406 is secured to one of the plurality of fastening slots 132 that allows the user to easily press the tire 402 to bead with the rim 204.

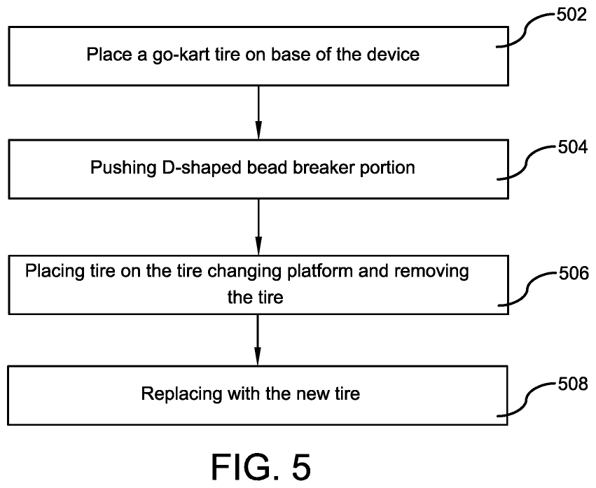

FIG. 5 illustrates a flow chart depicting a process of replacing a go-kart tire or small tire using the go-kart tire or small tire changing device of the present invention in accordance with the disclosed architecture. Initially, a tire to be changed is placed on the base of the device 100 such that the C-shaped or curvilinear bead breaker portion 122 is positioned along rim of the tire (Step 502). Then, the bead of the tire is broken off the rim by pushing C-shaped or curvilinear bead breaker portion 122 using the handle 116 to release the seal of the tire (Step 504). Thereafter, the tire is placed on the tire changing platform 124 and the bevel end of the pry bar 126 is used for removing the tire from the rim (Step 506). Finally, a new tire is placed and is installed using the opposite end of the pry bar 126 that has the tire inserting member 404 (Step 508).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “go-kart tire or small tire changing device”, “tire-changing device”, “go-kart tire or small tire changing machine”, and “device” are interchangeable and refer to the go-kart tire or small tire changing device 100 of the present invention.

Notwithstanding the forgoing, the go-kart tire or small tire changing device 100 of the present invention can be of any suitable size and configuration as is known in the art without affecting the overall concept of the invention, provided that it accomplishes the above stated objectives. One of ordinary skill in the art will appreciate that the go-kart tire or small tire changing device 100 as shown in the FIGS. 1-4 are for illustrative purposes only, and that many other sizes and shapes of the go-kart tire or small tire changing device 100 are well within the scope of the present disclosure. Although the dimensions of the go-kart tire or small tire changing device 100 are important design parameters for user convenience, the go-kart tire or small tire changing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable small tire changing device comprising:
a tire changing device having a base, a vertical tubing extending upward from said base, a tire changing portion integrated proximal to an upper end of said tubing, a tire bead breaker unit slidably attached to said tubing, and a pry bar;
wherein said tire bead breaker having a fastener for selectively securing said tire bead breaker along said tubing;
wherein said tire bead breaker unit having a handle and a grip for pivotally moving a lever portion relative to said tubing;
wherein upon placing the small tire onto said base, said bead breaker unit having a curvilinear bead breaker portion for breaking a bead of a tire between an edge of the small tire and a rim edge upon actuation of said handle downward; and
further wherein thereafter said tire changing portion having a platform upon which the small tire is supported and removed with said pry bar pivoting around said upper end of said tubing.

2. The portable small tire changing device of claim 1, wherein said base having a groove for storing said pry bar on a top surface of said base.

3. The portable small tire changing device of claim 2, wherein said tire changing portion having a fastener for fastening said platform at different positions along said tubing.

4. The portable small tire changing device of claim 3, wherein said tubing having a plurality of fastener slots for engaging an end of said pry bar for leveraging said pry bar against the edge of a new tire for installation.

5. The portable small tire changing device of claim 4, wherein said platform having a clamp thereunder for holding said grip during non-use of said portable tire changing device.

6. The portable small tire changing device of claim 5, wherein said base is rectilinear.

7. The portable small tire changing device of claim 6, wherein said tubing having a height from 24 inches to 32 inches.

8. A portable small tire changing device comprising:
a tire changing device having a base, a vertical tubing extending upward from said base, a tire changing portion integrated proximal to an upper end of said tubing, a tire bead breaker unit slidably attached to said tubing, and a pry bar;
wherein said tire bead breaker having a fastener for selectively securing said tire bead breaker along said tubing;
wherein said tire bead breaker unit having a handle and a grip for pivotally moving a lever portion relative to said tubing;
wherein upon placing the small tire onto said base, said bead breaker unit having a curvilinear bead breaker portion for breaking a bead of a tire between an edge of the small tire and a rim edge upon actuation of said handle downward;
wherein thereafter said tire changing portion having a platform upon which the small tire is supported and removed with said pry bar pivoting around said upper end of said tubing;
wherein said pry bar having a first claw end for inserting between the bead of the tire and a rim edge for lifting a bead edge of the tire over the rim edge;
wherein said pry bar having a second roller end including a supporting fastener for securing and pivoting around one of a plurality of fastener slots on said tubing; and
further wherein said second roller end having a tire inserting member for rolling and pressing against the bead of another tire to seal the bead of the another tire with the rim edge.

9. The portable small tire changing device of claim 8, wherein said base having a groove for storing said pry bar on a top surface of said base.

10. The portable small tire changing device of claim 9, wherein said tire changing portion having a fastener for fastening said platform at different positions along said tubing.

11. The portable small tire changing device of claim 10, wherein said plurality of fastener slots for selectively engaging said supporting fastener of said second roller end of said pry bar for leveraging said pry bar against the edge of the another tire for installation.

12. The portable small tire changing device of claim 11, wherein said platform having a clamp thereunder for holding said grip during non-use of said portable tire changing device.

13. The portable small tire changing device of claim 12, wherein said base is rectilinear.

14. A method of changing a small tire with a portable tire changing device, the method comprising the steps of:
providing a portable tire changing device having a base, a vertical tubing extending upward from said base, a tire changing portion integrated proximal to an upper end of said tubing, a tire bead breaker unit slidably attached to said tubing, and a pry bar;
selectively securing said tire bead breaker along said tubing with a fastener, wherein said tire bead breaker unit having a handle and a grip for pivotally moving a lever portion relative to said tubing;
placing a small tire onto said base;
actuating downward said handle and breaking a bead of the tire, wherein said bead breaker unit having a curvilinear bead breaker portion for breaking the bead of the small tire between an edge of the small tire and a rim edge;
moving the small tire from said bead breaker unit to said tire changing portion, wherein said tire changing portion having a platform upon which the small tire is supported;
inserting a first claw end of said pry bar between the bead of the small tire and a rim edge;
lifting a bead edge of the small tire over the rim edge;
pivoting said pry bar around said upper end of said tubing;
removing the small tire;
supplying another small tire to the rim edge;
securing and pivoting a second roller end of said pry bar with a supporting fastener around one of a plurality of fastener slots on said tubing; and
rolling and pressing against the bead of the another small tire with a tire inserting member of said second roller end to seal the bead of the another small tire with the rim edge.

15. The method of changing a small tire of claim 14, wherein said base having a groove for storing said pry bar on a top surface of said base.

16. The method of changing a small tire of claim 15, wherein said tire changing portion having a fastener for fastening said platform at different positions along said tubing.

17. The method of changing a small tire of claim 16, wherein said plurality of fastener slots for selectively engaging said supporting fastener of said second roller end of said pry bar for leveraging said pry bar against the edge of the another small tire for installation.

18. The method of changing a small tire of claim 17, wherein said platform having a clamp thereunder for holding said grip during non-use of said portable tire changing device.

19. The method of changing a small tire of claim 18, wherein said base is rectilinear.

20. The method of changing a small tire of claim 19, wherein the another small tire is a new tire.
